(19) United States
(12) Patent Application Publication
(10) Pub. No.: US 2008/0075597 A1
(43) Pub. Date: Mar. 27, 2008

(54) Systems for powering remote-controlled aircraft

(76) Inventor: Charles Brocklehurst, Cross Hill, SC (US)

Correspondence Address: THOMAS, KAYDEN, HORSTEMEYER & RISLEY, LLP, 600 GALLERIA PARKWAY, S.E., STE 1500, ATLANTA, GA, 30339-5994, US

(21) Appl. No.: 11/525,503

(22) Filed: Sep. 22, 2006

(51) Int. Cl. B64C 11/06

(52) U.S. Cl. 416/147

(57) ABSTRACT

Systems for powering remote-controlled aircraft are provided. A representative system comprises control circuitry operative to control operation of a propeller pitch motor. The control circuitry has a first operating mode and a second operating mode. The first operating mode is active in response to a rotational speed of the propeller correlating to an under-speed condition with respect to a nominal rotational speed of the propeller. In the first operating mode, the control circuitry powers the propeller pitch motor such that the pitch of the blades can be increased but not decreased. The second operating mode is active in response to the rotational speed of the propeller correlating to an over-speed condition with respect to the nominal rotational speed of the propeller such that the control circuitry does not return to the first operating mode until being reset. In the second operating mode, the control circuitry powers the propeller pitch motor such that the pitch of the blades can be selectively increased and decreased.

### TECHNICAL FIELD

The invention relates to propulsion and control systems for remote-controlled aircraft.

### DESCRIPTION OF THE RELATED ART

Remote-controlled aircraft, such as those used by hobbyists for recreational purposes, can vary significantly in size and complexity. In this regard, much of such complexity exists due to attempts to replicate, in a scaled-down manner, performance characteristics and capabilities typically found in full-sized piloted aircraft. However, unlike a piloted aircraft in which human intervention can be relied upon for direct manipulation of aircraft components, remote-controlled aircraft typically use radio frequency-controlled servos for controlling onboard components. Thus, a somewhat higher degree of automation may be required in remote-controlled aircraft than may be necessary in piloted aircraft. To further complicate this issue, remote-controlled aircraft typically have limited weight and stowage capacity. Therefore, accommodating equipment in a remote-controlled aircraft for automating various functions can be quite difficult.

### SUMMARY OF THE INVENTION

Systems for powering remote-controlled aircraft are provided. In this regard, an exemplary embodiment of such a system, in which the aircraft incorporates a variable pitch propeller having pitch-adjustable blades and a propeller pitch motor operative to adjust pitch of the blades, comprises control circuitry operative to control operation of the propeller pitch motor. The control circuitry exhibits a first operating mode and a second operating mode. The first operating mode is active in response to a rotational speed of the propeller correlating to an under-speed condition with respect to a designated rotational speed of the propeller, wherein, in said first operating mode, the blades of the propeller are operated at a constant pitch. The second operating mode isg active in response to the rotational speed of the propeller correlating to an over-speed condition with respect to the designated rotational speed of the propeller, wherein, in said second operating mode, said control circuitry powers the propeller pitch motor such that the pitch of the blades can be selectively increased and decreased.

Another embodiment of such a system comprises control circuitry operative to control operation of a propeller pitch motor. The control circuitry has a first operating mode and a second operating mode. The first operating mode is active in response to a rotational speed of the propeller correlating to an under-speed condition with respect to a nominal rotational speed of the propeller. In the first operating mode, the control circuitry powers the propeller pitch motor such that the pitch of the blades can be increased but not decreased. The second operating mode is active in response to the rotational speed of the propeller correlating to an over-speed condition with respect to the nominal rotational speed of the propeller such that the control circuitry does not return to the first operating mode until being reset. In the second operating mode, the control circuitry powers the propeller pitch motor such that the pitch of the blades can be selectively increased and decreased.

Another exemplary embodiment of such a system comprises a variable pitch propeller having pitch-adjustable blades, a speed-sensing system, a speed set component, a propeller pitch motor, and control circuitry. The variable pitch propeller is operative to provide the remote-controlled aircraft with thrust. The speed-sensing system is operative to output a speed signal corresponding to a current rotational speed of the propeller. The speed set component is operative to provide an indication of a nominal rotational speed of the propeller. The propeller pitch motor is operative to adjust pitch of the blades of the propeller such that, for a given power setting of the remote-controlled aircraft, a decrease in the pitch of the blades increases the rotational speed of the propeller and an increase in the pitch of the blades decreases the rotational speed of the propeller. The control circuitry comprises a switch, a diode connected in parallel with the switch, and a full wave bridge rectifier. The control circuitry is operative to provide a first output and a second output, with each of the first output and the second output being responsive to the speed signal from the speed-sensing system and the indication of the nominal rotational speed of the propeller from the speed set component. The first output is provided to the switch and to the diode such that: in a first operating mode in which the switch is open, the diode is configured to provide the first output to the bridge rectifier for powering the propeller pitch motor such that the pitch of the blades can be increased but not decreased; and, in a second operating mode in which the switch is closed, the control circuitry is operative to power the propeller pitch motor such that the pitch of the blades can be selectively increased and decreased.

Other systems, methods, features and/or advantages of the present invention will be or may become apparent to one with skill in the art upon examination of the following drawings and detailed description. It is intended that all such additional systems, methods, features and/or advantages be included within this description and protected by the accompanying claims.

### BRIEF DESCRIPTION OF THE DRAWINGS

Many aspects of the invention can be better understood with reference to the following drawings. The components in the drawings are not necessarily to scale. Additionally, like reference numerals designate corresponding parts throughout the several views.

FIG. 1 is a schematic diagram illustrating an exemplary embodiment of a system for powering a remote-controlled aircraft.

FIG. 2 is a schematic diagram illustrating another exemplary embodiment of a system for powering a remote-controlled aircraft.

FIG. 3 is a schematic diagram illustrating another exemplary embodiment of a system for powering a remote-controlled aircraft, with the propeller operating in a first mode.

FIG. 4 is a schematic diagram illustrating the embodiment of FIG. 3, with the propeller operating in a second mode and exhibiting an over-speed condition.

FIG. 5 is a schematic diagram illustrating the embodiment of FIGS. 3 and 4, with the propeller operating in the second mode and exhibiting an under-speed condition.

FIG. 6 is a schematic diagram illustrating the embodiment of FIGS. 3-5, with the propeller operating in the second mode and exhibiting an on-speed condition.

### DETAILED DESCRIPTION

Systems for powering remote-controlled aircraft are provided. In this regard, some embodiments are able to provide, via electronic circuitry, various functions that are typically implemented through mechanical systems in full-scale piloted aircraft. Specifically, some embodiments incorporate the use of a low pitch stop that is established by a switch. The low pitch stop sets a minimum pitch of the blades of a variable-pitch propeller when the propeller is operating in a first (“constant pitch”) mode. In some of these embodiments, a second (“variable pitch”) mode of operation enables variable pitch operation of the propeller. In this second mode, the pitch of the blades may be controlled to maintain a selected rotational speed of the engine and/or propeller.

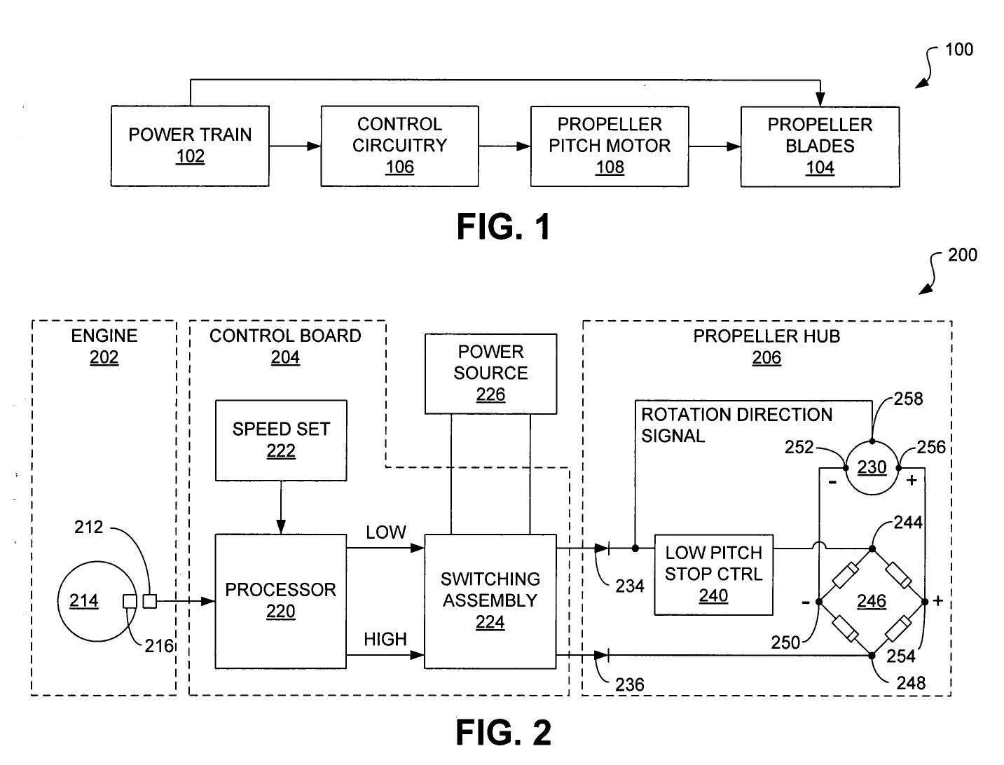

Referring now in detail to the drawings, FIG. 1 is a schematic diagram illustrating an exemplary embodiment of a system for powering a remote-controlled aircraft. In particular, system 100 includes a power train 102 that is used to rotate propeller blades 104. The propeller blades are variable-pitch blades, in that the pitch of each blade is adjustable. Although not depicted in FIG. 1, the blades 104 are mounted to a propeller assembly such that the blades can be rotated in concert by the power train for providing thrust to the remote-controlled aircraft.

Also depicted in FIG. 1 is control circuitry 106. The control circuitry receives input corresponding to the current rotational speed of the propeller blades. Responsive to the current rotational speed, the control circuitry can provide control signals to a propeller pitch motor 108 that is configured to adjust the pitch of the blades based on the control signals. Notably, if the current rotational speed is within a range of acceptable speeds, the control circuitry can discontinue providing control signals to the propeller pitch motor, thereby indicating that adjustment of the blade pitch is not required. Alternatively, control signals indicating that the blade pitch is acceptable could be provided. Regardless of the particular configuration, responsive to determining that the speed is acceptable, blade pitch adjustment is not required.

If the control circuitry determines that the current rotational speed of the propeller blades is not within the acceptable range of speeds, the control circuitry is able to provide control signals for instructing the propeller pitch motor to either increase or decrease the pitch of the blades as necessary. Notably, for a given power setting established by an engine (not shown) of the power train, a decrease in the pitch of the blades increases the rotational speed of the propeller and an increase in the pitch of the blades decreases the rotational speed of the propeller. Thus, if the propeller exhibits an over-speed condition, in which the rotational speed is higher than desired, the control circuitry instructs the propeller pitch motor to increase the pitch of the blades. If, however, the propeller exhibits an under-speed condition, in which the rotational speed is lower than desired, the control circuitry instructs the propeller pitch motor to decrease the pitch of the blades.

FIG. 2 is a schematic diagram illustrating another exemplary embodiment of a system for powering a remote-controlled aircraft. As shown in FIG. 2, system 200 incorporates an engine 202, a control board 204 and a propeller hub 206. Engine 202 is a portion of a power train that includes various reciprocating and/or rotating components, the motion of each of which potentially corresponds to a rotational speed of the propeller. Thus, determining the speed of one or more of these components can provide an indication of the current rotational speed of the propeller.

In this embodiment, a sensor 212 is used to determine a rotational speed of a crank shaft 214 of the engine. Specifically, a magnet 216 is attached to the crank shaft and the sensor 212, e.g., a Hall sensor, is used to detect proximity of the magnet and, thus rotational speed of the crank shaft.

Output of the sensor 212 is provided as a first input to the control board. In particular, the control board incorporates a processor 220 that receives the first input from the sensor. In addition, the processor receives a second input corresponding to a desired rotational speed of the propeller. In this embodiment, the second input is provided by an adjustable dip switch 222 that used to established the desired (“nominal”) operating speed of the propeller.

Responsive to the first input and the second input, the processor outputs pitch request signals. In this embodiment, two such signals are available, i.e., a “LOW” pitch request signal and a “HIGH” pitch request signal. Each of these signals can be independently turned on and off to indicate a variety of propeller conditions. For instance, when the LOW pitch request signal is “ON,” the processor has determined that the current rotational speed of the propeller is less than the preset nominal speed (an under-speed condition) and, thus, a lower blade pitch is being requested. In contrast, when the HIGH pitch request signal is “ON,” the processor has determined that the current rotational speed of the propeller is higher than the preset nominal speed (an over-speed condition) and, thus, a higher blade pitch is being requested. Additionally, when both the LOW and HIGH pitch request signals are “OFF,” the processor has determined that the current rotational speed of the propeller is acceptable (on-speed condition) and that no change in blade pitch is being requested.

The pitch request signals are provided from the processor to a switching assembly 224 that also receives power signals from a power source 226, in this case, a battery. Based on these inputs, the switching assembly, e.g., an H bridge, provides control signals that are used to control operation of a propeller pitch motor 230. The propeller pitch motor then can alter the pitch of the propeller blades in response to the control signals.

In this regard, when the LOW pitch request signal is “ON” and the HIGH pitch request signal is “OFF,” the switching assembly outputs a first control signal exhibiting a negative polarity and a second control signal exhibiting a positive polarity. In contrast, when the LOW pitch request signal is “OFF” and the HIGH pitch request signal is “ON,” the switching assembly reverses the polarities of the control signals. Thus, the first control signal exhibits a positive polarity and the second control signal exhibits negative polarity. Notably, when both of the pitch request signals are “OFF,” no control signals are provided from the switching assembly in this embodiment.

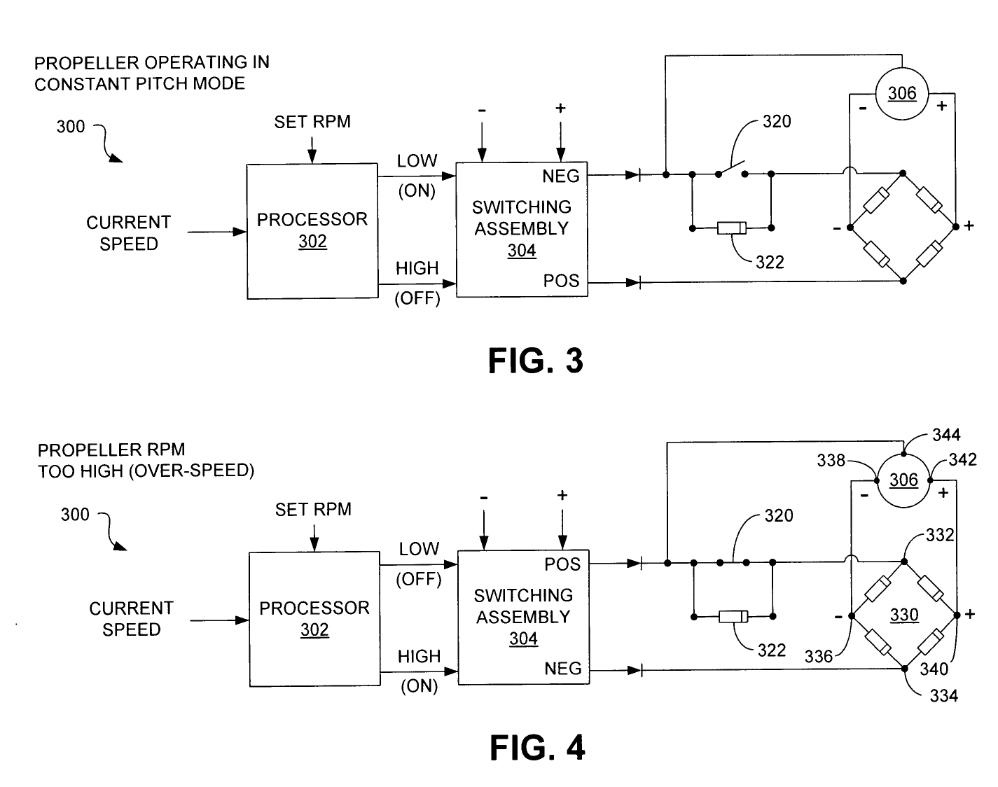

In FIG. 2, the first and second control signals are directed to the propeller hub via brushes 234 and 236, respectively. Specifically, the first control signal is directed to a low pitch stop controller 240 that is located within the propeller hub. The structure and operation of an embodiment of a low pitch stop controller will be described later with respect to FIGS. 3-6.

From the low pitch stop controller 240, the first control signal is directed to an input terminal 244 of a bridge rectifier 246. The second control signal is directed to an input terminal 248 of the bridge rectifier. The bridge rectifier ensures that negative polarity signals are provided from the negative output terminal 250 to the negative input terminal 252 of the propeller pitch motor, and that positive polarity signals are provided from the positive output terminal 254 to the positive input terminal 256 of the motor.

The first control signal also is directed as a third input to a mode terminal 258 of the propeller pitch motor, that is, in addition to the positive and negative polarity signals that are provided from the bridge rectifier to power the motor. This third input is used to designate the direction of rotation of the pitch propeller motor, thus determining whether the motor is driving the propeller blades to a higher or lower pitch. This particular control methodology allows only three inputs to be used for controlling the propeller pitch motor, which is located in the propeller hub. Notably, these three inputs are provided to the propeller hub using only 2 brushes. This significantly reduces the complexity of the system, in which low current control signals need not be used.

FIG. 3 is a schematic diagram illustrating another exemplary embodiment of a system for powering a remote-controlled aircraft, with the propeller operating in a first (“constant pitch”) mode. It should be noted that various system components, such as an engine, are not depicted in FIG. 3 to facilitate ease of illustration and description.

As shown in FIG. 3, a signal corresponding to the rotational speed of a propeller is provided as a first input to a processor 302. In addition, the processor receives a second input corresponding to a desired rotational speed of the propeller.

Responsive to the first input and the second input, the processor outputs pitch request signals. In this embodiment, two such signals are available, i.e., a “LOW” pitch request signal and a “HIGH” pitch request signal. Each of these signals can be independently turned on and off to indicate a variety of propeller conditions. For instance, when the LOW pitch request signal is “ON,” the processor has determined that the current rotational speed of the propeller is less than the preset nominal speed (an under-speed condition) and, thus, a lower blade pitch is being requested. In contrast, when the HIGH pitch request signal is “ON,” the processor has determined that the current rotational speed of the propeller is higher than the preset nominal speed (an over-speed condition) and, thus, a higher blade pitch is being requested. Additionally, when both the LOW and HIGH pitch request signals are “OFF,” the processor has determined that the current rotational speed of the propeller is acceptable (on-speed condition) and that no change in blade pitch is being requested.

The pitch request signals are provided from the processor to a switching assembly 304 that also receives power signals from a power source. Based on these inputs, the switching assembly provides control signals that are used to control operation of a propeller pitch motor 306. The propeller pitch motor then can alter the pitch of the propeller blades in response to the control signals.

In FIG. 3, the first and second control signals are directed via brushes to the propeller hub, which contains the propeller pitch motor. Specifically, the first control signal is directed to a low pitch stop controller that incorporates a switch 320 and a diode 322. The diode is electrically connected in parallel with the switch and is biased to pass positive polarity signals.

Since FIG. 3 depicts the system 300 in a constant pitch mode of operation, switch 320 is in an open position. That is, in the constant pitch mode, the rotational speed of the propeller has not exceeded a predetermined speed threshold established by the switch 320 and the switch remains open. Thus, the switch does not pass signals. Additionally, since the LOW pitch request signal is “ON” and the HIGH pitch request signal is “OFF,” the first control signal from the switching assembly exhibits a negative polarity and cannot be passed by the diode 322. Therefore, even though the propeller is rotating at less than the nominal speed, control signals are not provided to the propeller pitch motor to cause a decrease in pitch of the blades.

The constant pitch mode of operation typically is used during ground operations of a remote-controlled aircraft, such as during taxi and take-off roll, as well as during flight when a constant pitch propeller is desired. By way of example, this mode of operation may be desirable during aerobatic maneuvering when a flatter pitch of the blades can provide aerodynamic braking during descents and can enable the engine to accelerate quicker than if the blades were at higher pitch.

In this first mode, the pitch of the propeller is limited by the low pitch stop controller and, thus, the propeller functions as a constant or fixed-pitch propeller until the rotational speed of the propeller correlates with the nominal speed. Recall that the nominal speed can be set by a dip switch as in the embodiment of FIG. 2.

Responsive to the propeller rotational speed corresponding to (e.g., increasing beyond) the nominal speed, the system transitions to the second mode. During this transition, blade pitch can be increased as the diode 322 routes the first control signal (in this case, a positive polarity signal) to the propeller pitch motor via the bridge rectifier 330.

Also responsive to the propeller rotational speed corresponding to the nominal speed, the system causes switch 320 to close. Once closed, the system exhibits the second (“variable pitch”) mode of operation. It should be noted that although the switch 320 is set to close when the speed threshold is attained, there is still a time lag between sensing of the speed threshold and closing of the switch. This can cause the rotational speed of the propeller to momentarily exceed the speed threshold until the propeller motor is able to increase the blade pitch sufficiently. This can be a desirable characteristic in some embodiments as the time lag during this transition to the second mode of operation provides a momentary rotational speed increase in the propeller that can potentially be exploited in flight, for example. It should also be noted that, in some embodiments, the speed threshold for closing the switch and the nominal speed of the propeller need not be the same.

It should also be noted that, in some embodiments, the propeller pitch motor is a brushless motor. Brushless motors are used because of the high revolutions per minute (RPMs) that can be required for the propellers of remote-controlled aircraft. Although motors with brushes would be preferable (because simplified control circuits could be used), the high RPMs of the propellers can make motors with brushes unusable because the forces on the brushes tend to make them loose contact with their contact points.

FIG. 4 depicts the system 300 in the second (“variable pitch”) mode of operation. The variable pitch mode is achieved in response to the rotational speed of the propeller exceeding the predetermined speed threshold established by the switch 320. That is, the switch 320 is in a closed position and is able pass signals.

As shown in FIG. 4, the LOW pitch request signal is “OFF” and the HIGH pitch request signal is “ON” indicating that the current rotational speed of the propeller has exceeded the nominal speed. Thus, the first control signal exhibits a positive polarity and the second control signal exhibits a negative polarity.

Since the switch 320 is able to pass signals, the first control signal is directed to an input terminal 332 of a bridge rectifier 330. The second control signal is directed to an input terminal 334 of the bridge rectifier. The bridge rectifier ensures that negative polarity signals are provided from the negative output terminal 336 to the negative input terminal 338 of the propeller pitch motor, and that positive polarity signals are provided from the positive output terminal 340 to the positive input terminal 342 of the motor.

The first control signal also is directed as a third input 344 to the propeller pitch motor. This third input is used to designate the direction of rotation of the pitch propeller motor, thus determining whether the motor is driving the propeller blades to a higher or lower pitch. In this case, in which an over-speed condition is sensed, the positive polarity of the first control signal causes the propeller pitch motor to increase the blade pitch.

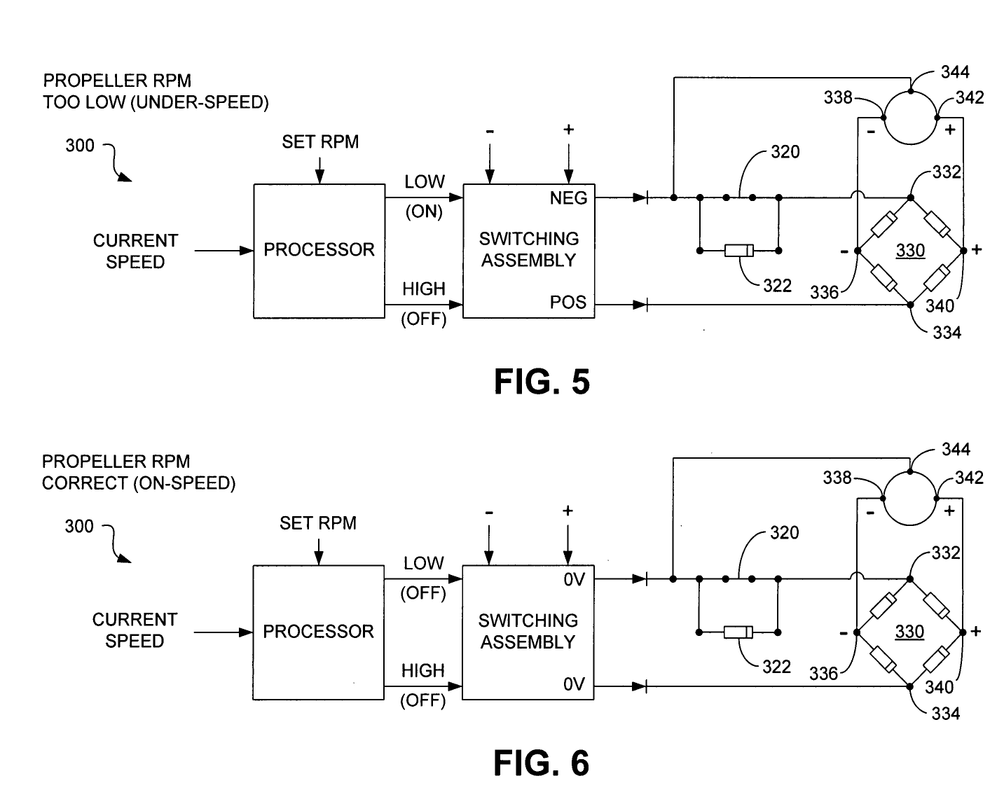

FIG. 5 is a schematic diagram illustrating the embodiment of FIGS. 3 and 4, with the propeller operating in the second mode and exhibiting an under-speed condition. As shown in FIG. 5, the LOW pitch request signal is “ON” and the HIGH pitch request signal is “OFF” indicating that the current rotational speed of the propeller is below the nominal speed. Thus, the first control signal exhibits a negative polarity and the second control signal exhibits a positive polarity.

Since the switch 320 is able to pass signals, the first control signal is directed to input terminal 332. The second control signal is directed to input terminal 334. As mentioned before, the bridge rectifier provides power to the propeller pitch motor.

The first control signal also is directed as the third input 344 to the propeller pitch motor. In this case, in which an under-speed condition is sensed, the negative polarity of the first control signal causes the propeller pitch motor rotate in the opposite direction compared to that depicted in FIG. 4 and increases the blade pitch.

FIG. 6 is a schematic diagram illustrating the embodiment of FIGS. 3-5, with the propeller operating in the second mode and exhibiting an on-speed condition. As shown in FIG. 6, when an on-speed condition is sensed, i.e., the current rotational speed of the propeller is within an acceptable range of operating speeds, both of the pitch request signals from the processor are “OFF.” Therefore, no control signals are provided from the switching assembly and the propeller pitch motor does not receive signals for altering the blade pitch.

It should be emphasized that the above-described embodiments are merely possible examples of implementations. Many variations and modifications may be made to the above-described embodiments. By way of example, some embodiments can incorporate a remotely operated reset control to reset the system from the second mode back to the first mode. This enables the first mode to be reestablished in flight. Additionally or alternatively, some embodiments can replace the rpm set control with a remotely operated component that can be used to alter the nominal speed of the propeller during operation as desired. All such modifications and variations are intended to be included herein within the scope of this disclosure.

1. A system for powering a remote-controlled aircraft comprising:
a variable pitch propeller having pitch-adjustable blades, the variable pitch propeller being operative to provide the remote-controlled aircraft with thrust;
a speed-sensing system operative to output a speed signal corresponding to a current rotational speed of the propeller;
a speed set component operative to provide an indication of a nominal rotational speed of the propeller;
a propeller pitch motor operative to adjust pitch of the blades of the propeller such that, for a given power setting of the remote-controlled aircraft, a decrease in the pitch of the blades increases the rotational speed of the propeller and an increase in the pitch of the blades decreases the rotational speed of the propeller; and
control circuitry comprising a switch, a diode connected in parallel with the switch, and a full wave bridge rectifier, the control circuitry being operative to provide a first output and a second output, each of the first output and the second output being responsive to the speed signal from the speed-sensing system and the indication of the nominal rotational speed of the propeller from the speed set component, the first output being provided to the switch and to the diode such that:
in a first operating mode in which the switch is open, the diode is configured to provide the first output to the bridge rectifier for powering the propeller pitch motor such that the pitch of the blades can be increased but not decreased; and
in a second operating mode in which the switch is closed, the control circuitry is operative to power the propeller pitch motor such that the pitch of the blades can be selectively increased and decreased.

2. The system of claim 1, wherein the propeller pitch motor has a mode terminal operative to receive the first output, a polarity of the first output determining a direction of rotation of the propeller pitch motor such that, responsive to receiving a first polarity of the first output, the propeller pitch motor increases the pitch of the blades and, responsive to receiving a second polarity of the first output when the switch is in the closed position, the propeller pitch motor decreases the pitch of the blades.

3. The system of claim 1, wherein the switch is moved from the open to the closed position in response to the current rotational speed of the propeller correlating with a preset rotational speed of the propeller.

4. The system of claim 1, wherein the switch is moved from the open to the closed position in response to the current rotational speed of the propeller correlating with the nominal rotational speed of the propeller.

5. The system of claim 4, wherein the switch is moved from the open to the closed position in response to the current rotational speed of the propeller exceeding the nominal rotational speed of the propeller.

6. The system of claim 1, wherein:
the system further comprises a power train coupled to the propeller and operative to rotate the propeller; and
the speed-sensing system comprises a component operative to rotate with the power train, and a sensor operative to sense rotation of the component and to generate the speed signal based on the sensed rotation of the component.

7. The system of claim 6, wherein the component is a magnet and the sensor is a Hall sensor.

8. The system of claim 1, wherein the speed set component is a dip switch.

9. A system for powering a remote-controlled aircraft, the aircraft comprising a variable pitch propeller having pitch-adjustable blades and a propeller pitch motor operative to adjust pitch of the blades, said system comprising:
control circuitry operative to control operation of the propeller pitch motor, said control circuitry having a first operating mode and a second operating mode,
said first operating mode being active in response to a rotational speed of the propeller correlating to an under-speed condition with respect to a designated rotational speed of the propeller, wherein, in said first operating mode, said control circuitry powers the propeller pitch motor such that the pitch of the blades can be increased but not decreased; and
said second operating mode being active in response to the rotational speed of the propeller correlating to an over-speed condition with respect to the designated rotational speed of the propeller such that said control circuitry does not return to said first operating mode until being reset, wherein, in said second operating mode, said control circuitry powers the propeller pitch motor such that the pitch of the blades can be selectively increased and decreased.

10. The system of claim 9, wherein, in said second operating mode, said control circuitry is operative to maintain the rotational speed of the propeller within a range of rotational speeds encompassing a nominal rotational speed of the propeller such that, for a given power setting of the remote-controlled aircraft, a decrease in the pitch of the blades increases the rotational speed of the propeller and an increase in the pitch of the blades decreases the rotational speed of the propeller.

11. The system of claim 9, wherein the control circuitry comprises a switch, and reset of the control circuitry occurs responsive to the switch being moved from a closed position to an open position.

12. The system of claim 11, wherein the control circuitry further comprises a diode electrically connected in parallel with the switch such that, in a first operating mode in which the switch is in the open position, the diode is configured to provide power to the propeller pitch motor.

13. The system of claim 9, wherein said control circuitry is operative to provide first and second signals, polarities of which are indicative of whether the rotational speed of the propeller is exhibiting an over-speed or an under-speed condition.

14. The system of claim 13, wherein said control circuitry is operative to provide the first signal and the second signal as power signals to power the propeller pitch motor, and a polarity of the first control signal is used to control a direction of rotation of the propeller pitch motor.

15. The system of claim 13, wherein said control circuitry comprises an H bridge, and the first signal and the second signal are output from the H bridge.

16. The system of claim 13, wherein:
said control circuitry comprises a bridge rectifier having a first input terminal, a second input terminal, a positive output terminal and a negative output terminal;
said first input terminal is operative to receive the first signal, said second input terminal is operative to receive the second signal, said positive output terminal is configured to be electrically connected to a positive input terminal of the propeller pitch motor, said negative output terminal is configured to be electrically connected to a negative input terminal of the propeller pitch motor.

17. The system of claim 9, further comprising a battery electrically connected to said control circuitry, said battery being operative to power said control circuitry.

18. The system of claim 9, further comprising means for powering said control circuitry.

19. A system for powering a remote-controlled aircraft, the aircraft comprising a variable pitch propeller having pitch-adjustable blades and a propeller pitch motor operative to adjust pitch of the blades, said system comprising:
control circuitry operative to control operation of the propeller pitch motor, said control circuitry exhibits a first operating mode and a second operating mode,
said first operating mode being active in response to a rotational speed of the propeller correlating to an under-speed condition with respect to a designated rotational speed of the propeller, wherein, in said first operating mode, the blades of the propeller are operated at a constant pitch; and
said second operating mode being active in response to the rotational speed of the propeller correlating to an over-speed condition with respect to the designated rotational speed of the propeller, wherein, in said second operating mode, said control circuitry powers the propeller pitch motor such that the pitch of the blades can be selectively increased and decreased.

20. The system of claim 19, wherein, after operating in said second mode, said control circuitry does not return to said first operating mode until being reset.
